(19) United States
(12) Patent Application Publication
(10) Pub. No.: US 2008/0086290 A1
(43) Pub. Date: Apr. 10, 2008

(54) Method for modeling task and workload

(76) Inventor: Ian A. Wilson, Port Orange, FL (US)

Correspondence Address: J. WILEY HORTON, ESQUIRE;Pennington, Moore, Wilkinson, Bell & Dunbar, P.A., 215 S. Monroe Street, 2nd Floor, Post Office Box 10095, Tallahasee, FL, 32302-2095, US

(21) Appl. No.: 11/906,816

(22) Filed: Oct. 4, 2007

Related U.S. Application Data
(60) Provisional application No. 60/849,236, filed on Oct. 4, 2006.

(51) Int. Cl. G06G 7/48; G06F 9/44

(52) U.S. Cl. 703/6; 705/7

(57) ABSTRACT

A method for modeling task, activity and workload of various human-implemented processes. The models created by this method may be further evaluated so that improvements can be made to the modeled processes. These improvements in modeled processes may include restructuring the human-implemented aspects of the process to take into account the human's cognitive and physical limitations. The model may also be used to identify the information flow aspects of the human cognitive activities allowing the specification and implementation of changes in the information flow or quality to result in improved human workloads.

### BACKGROUND OF THE INVENTION

1. Field of the Invention

This invention relates to the field of human factors. More specifically, the present invention comprises a method for improving an individual's performance of a high workload routine.

2. Description of the Related Art

According to modern cognitive theory, human cognition may be broken down into several different channels. All activities performed by a human utilize one or more of these channels. The particular cognitive channel that is being used depends upon the cognitive stage (whether the person is encoding/processing or responding), the type of response (whether the response is manual or vocal), the sensory modality used (whether visual or auditory), and the perceptual code (whether the “reasoning” is spatial or verbal). FIG. 3 illustrates the cognitive channels a person may utilize. When perceiving and processing, a person may be using the cognitive channels associated with verbal or spatial reasoning. The person's verbal or spatial reasoning may also either be auditory or visual. When selecting or executing a response, a person may be using a vocal channel (if responding by voice) or manual (if responding by action).

Humans can engage in multiple tasks or activities simultaneously when using different cognitive channels. This ability is not without limitation. The use of one cognitive channel interferes with the use of another. Accordingly, if multiple channels are used, less “loading” may be processed on each channel than when a single channel is used. This interference or conflict between cognitive channels can be assigned a degree of conflict. For example if a human tries to read a sentence (visual-verbal) and simultaneously tries to listen to someone speaking then one or the other activity will be blocked as they are both using the verbal cognitive channel and are in complete conflict. Other channels may used simultaneously with only partially interference.

There are many routines performed by individuals that are overly demanding on an individual's mental and physical resources. One example is in the field of air traffic control. Air traffic controllers operate in a high workload environment. Air traffic controllers manage many tasks simultaneously including visually monitoring radar displays, searching for objects on radar displays and data displays, reading text from radar and data displays, listening to speech on radios and telephones, monitoring for auditory warning tones, comprehending speech, problem solving/decision making, and responding to pilots and other controllers both manually and verbally. In the context of air traffic management, error caused by excessively high workloads can be fatal. Although many improvements have been made to help air traffic controllers perform their routines more effectively, incidents of error still occur regularly.

There are many other fields in which individuals engage in high workload routines. Despite the knowledge of the general limitations of human cognition in the field of human factors, there remains a need for a methodology that may be consistently applied to improve individual's performance of high-workload routines.

### BRIEF SUMMARY OF THE INVENTION

The present invention comprises a method for modeling task, activity and workload of various human-implemented processes. The models created by this method may be further evaluated so that improvements can be made to the modeled processes. These improvements in modeled processes may include restructuring the human-implemented aspects of the process to take into account the human's cognitive and physical limitations. The model may also be used to identify the information flow aspects of the human cognitive activities allowing the specification and implementation of changes in the information flow or quality to result in improved human workloads.

### DESCRIPTION OF THE SEVERAL VIEWS OF THE DRAWINGS

FIG. 1 is a schematic, illustrating the present invention.

FIG. 2 is a schematic, illustrating the present invention.

FIG. 3 is a schematic, illustrating a person's cognitive resource channels.

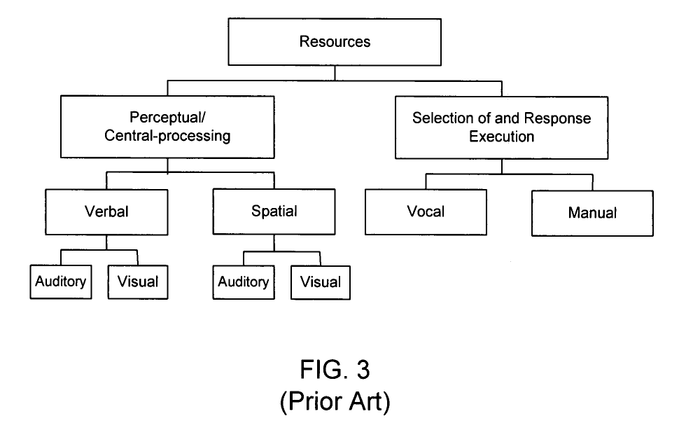

FIG. 4 is an activity timeline, illustrating the resource channel loadings on a controller when performing two tasks.

REFERENCE NUMERALS IN THE DRAWINGS

| | | | |
|---|---|---|---|
| 10 | method | 12 | step |
| 14 | step | 16 | step |
| 18 | step | 20 | step |
| 22 | step | 24 | step |
| 26 | step | 28 | step |
| 30 | step | 32 | step |
| 34 | step | 36 | step |
| 38 | step | 40 | step |
| 42 | step | 44 | step |
| 46 | step | 48 | step |
| 50 | step | 52 | step |
| 54 | activity timeline | 56 | first triggering event |
| 58 | second triggering event | 60 | intratask interference |
| 62 | intertask interference | 64 | intertask and intratask interference |
| 66 | intratask interference | 68 | first task |
| 70 | second task | 72 | verbal auditory activity |
| 74 | spatial visual activity | 76 | verbal visual activity |
| 78 | manual response activity | 80 | manual response activity |
| 82 | verbal response activity | 84 | spatial visual activity |
| 86 | manual response activity | 88 | verbal response activity |
| 90 | spatial visual activity | 92 | verbal response activity |
| 94 | verbal response activity | | |

### DESCRIPTION OF THE INVENTION

The present invention is a method for measuring and modeling human mental workload for various human-implemented processes. The models created by this process may be used to refine the order and extent of activities from which human-implemented processes are comprised to improve process efficiency and reduce human error. The knowledge of the order and extent of activities of which expert human-implemented processes are comprised may also be used in training non-experts The present invention accomplishes these and other objectives utilizing the method described herein.

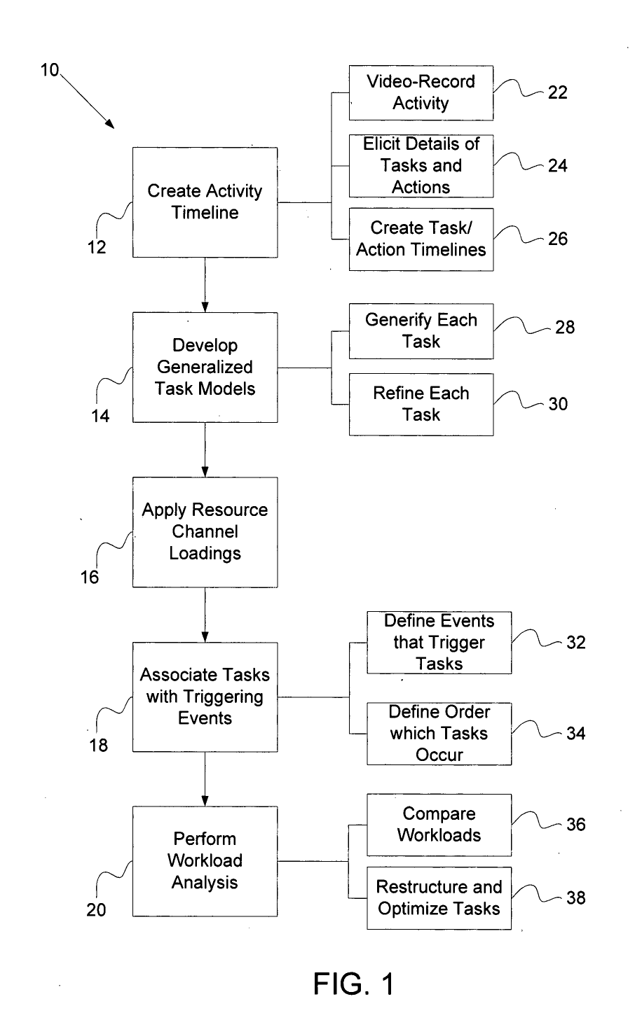

FIG. 1 is a schematic, illustrating modeling method 10. Modeling method 10 generally includes the steps of creating an activity timeline for a human-implemented process (step 12), developing generalized task models for the activity (step 14) under varying levels of task load, applying resource channel loadings to the task models (step 16), associating tasks with triggering events (step 18), and performing various workload analyses to diagnose weaknesses and/or optimize the human-implemented process (step 20). Each of the process steps will be considered in greater detail subsequently.

The proposed method may be used to model and quantify human workload across a nearly endless array of domains in a manner that does not rely solely on the subjective judgment of the human being measured. The method is especially useful as an assessment tool for analyzing high workload human-implemented tasks and activities, such as in air traffic management and assembly line operations. Nevertheless, modeling method 10 is useful in any application where it is desirable to quantify, study and improve a human-implemented task or activity. A task or activity may be considered “human-implemented” if the process or activity requires the use of a human's cognitive faculties.

Human workload may be measured in many ways. For example, workload may be measured in terms of the time it takes a person to complete a task or series of tasks. This is a very simple measurement of workload. Modern human factors and cognitive theory research supports the theory that humans operate on multiple resource channels. This use of multiple resources makes it possible for a person to engage in multiple activities or complete multiple tasks simultaneously. For example, a person can carry on a conversation while driving a car. Accordingly, a more sophisticated measurement of workload takes into account a person's use of multiple resource channels when completing tasks.

As mentioned previously, humans can engage in multiple tasks or activities simultaneously when using different cognitive channels. This ability is not without limitation. The use of one cognitive channel interferes with the use of another. Accordingly, if multiple channels are used, less “loading” may be processed on each channel than when a single channel is used. This interference or conflict between cognitive channels can be assigned a degree of conflict. For example if a human tries to read a sentence (visual-verbal) and simultaneously tries to listen to someone speaking then one or the other activity will be blocked as they are both using the verbal cognitive channel and are in complete conflict. Other channels may partially interfere—for example, listening to a radio instruction while noting the position of a set of gauges. The present invention allows the generation of matrices of conflict coefficients between cognitive channels.

Another variant on the way humans carry out tasks is their perception of the time constraints for finishing each task. Humans carry out tasks under varying task loads. If the load or perceived load is low then humans tend to extend or add activities. If the workload is high then humans may drop and/or shorten activities to the minimum to carry out the task. Thus there may be more than one generic set of activities and related cognitive workload for each task, dependent on the perceived task load.

The invention may be better understood by applying the proposed method to the domain of air traffic management. One way that the present invention can be used to improve air traffic management involves applying the modeling method to compare the workload and behavior patterns of air traffic controllers using traditional versus experimental air traffic management displays under varying levels of task load or perceived task load.

As illustrated in FIG. 1, an activity timeline is first created as denoted in step 12. Step 12 may include several sub-steps as shown in FIG. 1 (steps 22, 24, and 26). An activity timeline is created by video-recording the air traffic controller and recording all controller inputs to the system as the controller engages in standard air traffic control operations (step 22). The activity is recorded over a long enough period of time to capture all routine tasks under several levels of task loading. “Tasks” constitute definable functions performed by the controller which are initiated by a triggering ‘event’. Tasks can be further broken down into activities. “Activities” include both overt movements and covert mental processes performed during a task.

The video (or videos) and other recordings are then analyzed to identify the various tasks and activities that were performed according to step 24. The video and recordings are viewed in the presence of the controller, and as the recordings are incrementally advanced the controller may be asked to elucidate what tasks and activities were being carried out at certain points, especially where such activities were covert mental processes (for example, deciding which of two aircraft would be best deviated for avoidance). This allows the user of the modeling process to elicit details about what the controller was “doing” and “thinking” at various times during the tasks.

A timeline is then created, as shown in step 26, which includes the various tasks and actions that were performed. The timeline includes time data such as start and end of tasks and activities defining their duration, the time overlap for tasks and activities that occur concurrently, and the sequence of activities for each of the tasks. More than one task timeline may be produced for different levels of task loading.

Once a task timeline is created, generalized task models are developed (step 14). The generalized task models describe a task as a sequence of actions that occur each time a task is performed. As shown in FIG. 1, the development of generalized task models may be further broken down in to the steps of generifying each task and refining each task, steps 28 and 30, respectively. “Generifying” a task involves reducing a task to the actions that commonly occur each time the task is performed. For example, “generification” involves identifying which activities occur every time a task is performed, the sequence which the activities occur, and the normal duration of those activities.

The task models may be refined during generification. This involves removing actions from the sequence that are atypical or that do not otherwise belong in the associated task model. For example, a particular action may be more properly associated with the model for a different task although the action occurred in the middle of a sequence of actions which correspond to the same task. As an example, a controller may be interrupted during a task to carry out another task and after the interrupt repeat the particular activity that was interrupted. The repeated activity should be removed from the generic task as it was due to the interrupt.

Once generalized task models are created, values for the loading on each resource channel are assigned to each activity performed with each task (step 16). This step involves determining which resource channels are used in each activity. If multiple channels are used for an activity, interference may be accounted for to insure that resource channel loadings for each task model accurately reflect the controller's actions when the controller is performing the task.

Triggering events are then associated with each task and activities as illustrated by step 18. “Triggering events” are circumstances or events that prompt the task. In the air traffic management context, triggering events may be display items which are observed by the controller, statements or questions directed to the controller, or the completion of other tasks and activities performed by the controller. This step generally includes defining events that trigger tasks (step 32) and defining order which tasks occur (step 34).

Workload analysis is then performed as indicated in FIG. 1 by step 20. “Workload” may be evaluated in many different ways. For each activity the invention sums the assessed loadings on each cognitive channel used by the activity and adjusts the loading up and down dependent on conflicts between those cognitive channels and those used by any parallel activity. The workload for each activity and task is then available for display and comparison. Other information such as the cognitive channels that are most loaded by each task and activity is also available. Human mental workload can be measured both in terms of the duration of time spent performing a task and/or the overall loading of resource channels when performing the task. The various workloads for different tasks and activities may be compared with each other (step 36) in order to determine which tasks are associated with the highest workloads. This may indicate to the evaluator where process improvements may be most beneficial such as provision of decision support tools that pre-process the information for the human reducing cognitive workload.

Steps 12, 14, 16, 18, and 20 may then be repeated after the environment is changed such as changing the presentation of a radar display; providing decision support tools that reduce the mental load on the controller; or after activities and tasks have been restructured. New activity timelines and task models are created that reflect the tasks performed in the new environment or the tasks performed using a restructured activity sequence. This process can be repeated iteratively until an optimal distribution of workload is achieved.

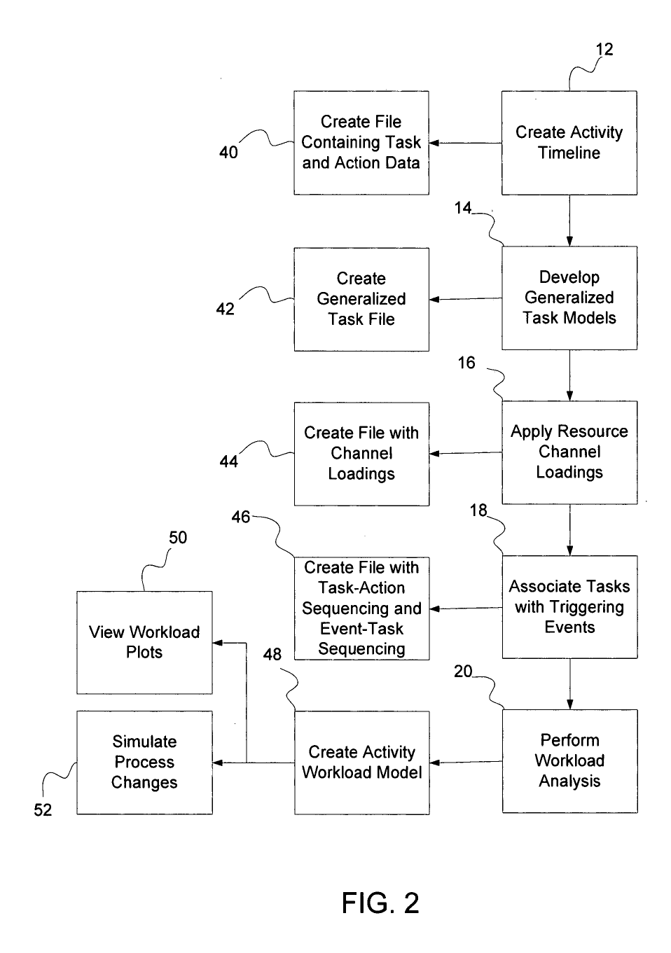

The aforementioned process may also be implemented as software on a computer as illustrated in FIG. 2. The software enables the user to create task and activity models and perform workload analysis on the models. As in the previously described process, activity timelines are first created (step 12). The activity timelines are split into two groups those for overt activities (those that can be seen being carried out by the subject) and covert activities (those that are not visible but are mental tasks also imposing a cognitive workload). Timelines are built for the various tasks, and overt and covert activities that were performed. The timeline also includes time data such as the duration of tasks and actions, the time overlap for tasks and actions that occur concurrently, and the sequence of actions for each of the tasks.

The user then creates a file containing task and action data as illustrated in step 40. If the activity was recorded digitally, software may be used to place marker “segments” on the timeline to denote the beginning and end of tasks and their associated activities. Each segment may include a description such as a task and action reference names and explanations. The software may then be used to determine time elements such as duration and concurrency. Alternatively, a file can be created by manually entering task information and timing details.

This file may be used to sort the various tasks and actions that were performed and assist the user in developing generalized task models (step 14). For example, tasks and actions that were performed multiple times can be grouped together. This helps the user identify the common elements for each task or action so that task models can be generalized. Also details which vary each time a task is performed, such as the duration of a task, can be averaged. Once generalized task models are developed, the user created a generalized task file as reflected in step 42. The generalized task files associate timing and action data that are common for the task for later reference.

When a subject has a high perceived task load they may reduce the duration or number of activities that they carry out to complete a task, therefore, generalization is valid only if the subject is working under the same pressure. The exercise of producing task and activity files can be repeated with subjects under differing levels of task load from under-loaded to overloaded (or perceived overloaded) thus producing files valid for each level of workload.

The user then applies resource channel loadings to the task files as indicated by step 16. As mentioned previously, applying resource channel loadings involves identifying which resource channels are used when each activity is performed. A file is then created which includes the channel loadings (step 44). Interference data may be incorporated with the resource channel loadings for verification. For example, if the user attempts to input an impossible resource channel loading scenario (such as the concurrent use of mutually exclusive channels) the program can prompt the user of the error.

The user then associates tasks and actions with triggering events as shown in step 18. Some tasks may be triggered by more than one event or occurrence, and some tasks may trigger multiple other tasks. The various causal relationships are identified and entered as “rules” for the models. Tasks are linked with actions and other tasks as they would normally occur. External inputs which prompt tasks and actions are also identified and linked. A file is created containing these linkages and rules as shown in step 46.

Once the user has created the aforementioned files, workload analysis may be performed as indicated by step 20. It is at this step where the most significant advantages of the software may be realized. Activity workload models may be constructed and evaluated for various conditions (step 48). Because task-action sequencing and event-task sequencing has already been performed, the user can simulate process changes (step 52) and construct accurate models “virtually.” Workload plots can be generated and viewed (step 50) for easy comparison. Accordingly, process optimization may be performed iteratively using the software without requiring as much physical real-world experimentation.

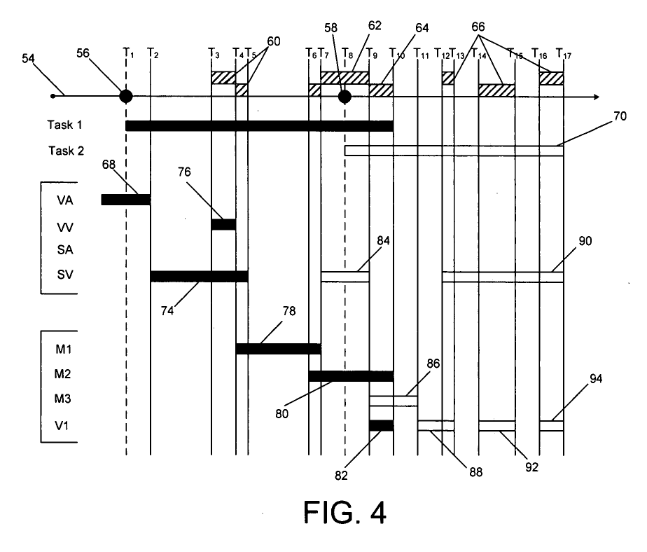

FIG. 4 illustrates an activity time line for a portion of a process in which two tasks are performed. The present example considers an air traffic controller who, while performing a typical routine, performs two tasks which overlap in time. Activity timeline 54 shows a period of time in which the air traffic controller performs two tasks—the adjustment of a display and the communication of an approach vector with a pilot. Activity timeline 54 is marked with various time markers (T₁-T₁₇) to indicate the time when significant events occur.

First triggering event 56 occurs at time T₁ which triggers the performance of first task 68. In the present example, first triggering event 56 is a request given by a pilot for the air traffic controller to grant landing clearance and provide the pilot with a control vector. First task 68 involves the task of adjusting the air traffic controller's display to see the objects necessary for the controller to respond to the request. Second task 70 involves communication with the pilot and establishing an approach vector. Thus, in the present example second triggering event 58 is dependent upon first triggering event 56. The black bars (72, 74, 76, 78, 80 and 82) identify discrete activities which are performed by the controller when performing first task 68. The white bars (84, 86, 88, 90, 92 and 94) identify discrete activities which are performed by the controller when performing second task 70. Each activity is separated into a row based upon the resource channel(s) employed by the controller when performing the activity.

First triggering event 56 occurs while controller is performing listening to radio transmissions as indicated by verbal auditory activity 72. When the pilot request landing clearance and an approach vector, the controller begins searching the display to locate an object of interest on the display as indicated by spatial visual activity 74. While looking at the display, the controller notes and reads a relevant portion of text on the display as indicated by verbal visual activity 76. Upon reading the portion of text, the controller begins to make an adjustment to the display as indicated by manual response activity 78. Before finishing the adjustment of manual response activity 78, the controller begins performing another adjustment with his other hand as indicated by manual response activity 80. As the controller finishes the last manual response activity 80, the controller performs vocal response activity 82 in which the controller verbally indicates his readiness to communicate with the pilot.

Upon completion of manual response activity 78, the controller begins scanning the display again as indicated by spatial visual activity 84. This activity triggers second triggering event 58. Once the desired object is located in the display, the controller performs manual response activity 86 and then communicates with the pilot again as indicated by vocal response activity 88. While performing vocal response activity 88, the controller once again begins observing the display as indicated by spatial visual activity 90. The controller communicates with the pilot twice more when providing the approach vector as illustrated by vocal response activities 92 and 94.

The reader will note that when performing these basic tasks, there were many instances when the controller “multitasked.” Time intervals in which multiple activities were performed simultaneously are indicated above activity timeline 54 in FIG. 4. As mentioned previously, interference is caused when the controller uses multiple resource channels simultaneously. The interference may be “intertask” (i.e., the interfering activities relate to different task) or “intratask” (i.e., the interfering activities relate to the same task). Intratask interference 60, occurring between T₃ and T₄, T₄ and T₅, and T₆ and T₇, indicate activities performed during first task 68 alone which create some level of cognitive interference. Intratask interference 66, occurring between T₁₂ and T₁₃, T₁₄ and T₁₅, and T₁₆ and T₁₇, indicate activities performed during second task 70 alone which create some level of cognitive interference. Intertask interference 62, occurring between T₇ and T₉, indicates activities performed when performing both first task 68 and second task 70 which together create interference. Intertask and intratask interference 64, occurring between T₉ and T₁₀, indicates a period of time in which both intertask and intratask interference occurred.

Interference matrices, which are known to those in the field of human factors, may be used to evaluate the level of interference caused by the simultaneous use of two or more resource channels. Objective values of the interference may be used to evaluate whether the level of interference is acceptable in a particular instance or whether action is needed to ameliorate the interference. There are many ways to ameliorate interferences such as: (1) restructuring a task to avoid overlap of certain activities; (2) restructuring a process to prevent activities from one task from overlapping activities of another task; (3) redesign of instrumentation or other tools; or (4) delegating activities to alternate parties.

In the example of FIG. 4, first task 68 and second task 70 have already been “generified” to identify the activities (and sequencing of activities) which are normally performed when performing the tasks. Thus, each of the black bars represent a generic version of first task 68 and the white bars represent a generic version of second task 70. Each time the controller performs a task, however, the controller may perform other activities that are not a normal part of the task. These activities have been omitted from FIG. 4. Further, the actual duration of each activity shown in FIG. 4 represents an average duration for performing such an activity.

In order to determine the discrete activities performed during a task, it is particularly helpful to observe the individual's actual performance of the task under ordinary workload conditions. In the example shown in FIG. 4, it would be helpful to make a video recording of the controller while the controller is performing the tasks. The controller may then be interviewed to discern the discrete activities performed while performing the task. For example, a human factors expert may watch the video with the controller and ask the controller what he or she was doing at different moments during the task. It is preferable to record multiple performances of the same task, so that a better generified task model can be created.

One particularly valuable application of the present invention is in the domain of Fast-Time Simulation (“FTS”). Referring back to step 44 of FIG. 2, the reader should now appreciate that task files can be created that contain the resource channel loading data of FIG. 4. For example, the task file for first task 68 should describe the sequencing and duration of the loading of each resource channel. Likewise, the task file for second task 70 should describe the sequencing and duration of the loading of each resource channel when performing second task 70. As mentioned previously, each task is associated with a triggering event. Thus, when performing a FTS, an analyst may “place” triggering events at various locations on an activity timeline and see where interferences would be caused. If the analyst placed the triggering events at the locations illustrated in FIG. 4, an interference grid (such as the one illustrated above the activity timeline 54) may be shown.

Interferences which exceed defined parameters may be color coded (or otherwise marked) to show where “unacceptable” workload conditions would exist. The acceptability of workload conditions depends on (1) the level of the interference, and (2) the significance of the task. For example, greater tolerance may be allowed for the interferences occurring during tasks which, if performed incorrectly, are unlikely to result in any damage. Also, some interferences produce higher levels of impairment than others. Thus, interferences that result in 90% effectiveness may not be a concern while interferences that result in 50% effectiveness may require amelioration.

When performing a FTS, the analyst may locate triggering events at various points in time on an activity timeline to determine where unacceptable resource loadings occur. This is illustrated as step 52 in FIG. 2. FTS software may be configured to load all task files associated with the triggering events to complete the activity timeline with all activities and tasks which are prompted by the triggering events. This allows the analyst to simulate and analyze task sequencing scenarios which may not have been attempted before. In the context of the air traffic management example, the analyst can evaluate the consequences of (1) adding the number of controllers operating at one time; (2) reducing the numbers of controllers operating at one time; (3) reordering or changing activities performed within a task; (4) resequencing tasks performed within a process or routine; (5) typical or atypical sequencing of triggering events; (6) exceeding perceived operational limits.

Referring back to step 50 of FIG. 2, the workload plot of FIG. 4 is only one such presentation of workload that can be generated. There are many ways that workload can be shown. For example, an analyst may only be concerned with the occurrence of a particular type of interference. Under such circumstances, software may be configured to generate a display that shows when the particular type of interference occurs.

Although the previous description considers the present invention in the context of air traffic management, the present invention is useful in many other domains. As an example automobile manufacturers, federal agencies and cell phone companies are all interested in how cell phone use while driving influences driving ability. The modeling method could be used to measure all the component elements of a specific driving task being done while speaking on a cell phone.

For example, the tasks and activities involved in answering a question about directions to a location on the cell phone while approaching a complex junction on a 4 lane highway may be modeled. Through videotaped sequencing and interviews with the driver, the method can be used to create a list of tasks and actions involved in negotiating the junction. This task may include many different tasks, such as checking the rearview mirror, applying the brake, turning the steering wheel several degrees, visually scanning the road, reading road signs and markings, discriminating the best path to take, responding to auditory input on the cell phone and accessing long-term memory to provide appropriate verbal response. All these items are then measured with respect to the resource channels used and duration of time over which the tasks occurred.

Once these tasks are identified and generalized, they may be analyzed using theoretical models to determine how the various actions and used of multiple resource channels interfere with one another to create higher or lower levels of workload. The results of this modeling analysis allows the user to evaluate at each point in the overall task where workload increases or decreases. This information could be used to modify the driving task, modify the cell phone task, or develop safety regulations related to signage on junctions or cell phone usage in order to maintain optimal or acceptable workloads.

The modeling process may also be used in industry domains to improve manufacturing processes, especially where assembly lines are utilized. All assembly line tasks require multiple movements or behaviors to complete a work assignment (e.g. screwing a piece of metal onto a car body or soldering components onto a circuit board). Efficient use of time and effort are critical to the productivity of an assembly line. The modeling process can be used to analyze how each task on the assembly line is done and the workload associated with each to determine if making changes to a specific task(s) (e.g. breaking an identified task up into smaller tasks, adding more time to a specific station on the assembly line, rotating the order in which tasks are done) could increase overall employee productivity, thus increasing overall line efficiency.

The modeling process is also useful for job training. For example, the process may be employed to compare how novices and experts engage in specific tasks and the resultant workload patterns of each of their profiles. For instance, the user may utilize the process to study how a pilot with 4000 hours of flight time navigates an approach in moderately cloudy and windy circumstances versus how a novice pilot with 40 hours of flight time engages the approach. By comparing the differences between the two extremes, individuals or companies developing training in that domain can focus on key areas in which novices could be trained to act more like experts, thus enhancing their post-training performance.

The modeling process can be used to define the best way to carry out tasks in systems that are newly designed and have no subject matter experts. The activities within the tasks and their most optimal ordering can be modeled using the software and the least workload activity series identified. This can then be used in the development of initial training for the use of the novel system.

In all of the aforementioned examples, understanding the components of a specific task the cognitive channel loadings and the associated workload would allow researchers, regulatory agencies and companies to develop procedures that are more attuned to human cognitive and physical abilities. The proposed modeling system therefore can be utilized to increase productivity and efficiency as well as reduce human error.

Having described my invention, I claim:

1. A method for improving an individual's performance of a routine comprising:
a. observing said individual's performance of said routine;
b. creating an activity timeline for said routine, said activity timeline identifying a first task and a second task performed by said individual when performing said routine;
c. identifying a first plurality of activities performed by said individual when performing said first task and a second plurality of activities performed by said individual when performing said second task;
d. developing a first generalized task model for said first task and a second generalized task model for said second task, said first generalized task model describing said first task as a first sequence of actions that occur each time said first task is performed, said second generalized task model describing said second task as a second sequence of actions that occur each time said second task is performed;
e. detailing said first sequence of actions and said second sequence of actions on said activity timeline;
f. applying resource channel loading values to each of said first sequence of actions and said second sequence of actions on said activity timeline to account for interferences among resource channels of said individual;
g. analyzing said activity timeline after applying said resource channel loading values to determine a first interference occurring when performing said first task and said second task, said first interference identifying an instance on said activity timeline in which the resource channels required to perform said first task interfere with the resource channels required to perform said second task;
h. adjusting said routine to ameliorate said first interference.

2. The method of claim 1, further comprising identifying a first triggering event for said first task and a second triggering event for said second task, said first triggering event and said second triggering event defining circumstances prompting said individual to perform said first task and said second task, respectively.

3. The method of claim 2, further comprising the steps of:
a. writing a first task file, said first task file describing a sequence and a duration for each of said first plurality of activities; and
b. writing a second task file, said second task file describing a sequence and a duration for each of said second plurality of activities.

4. The method of claim 3, further comprising the steps of providing a computer and fast time simulation software configured to construct an activity timeline by employing a plurality of task files including said first task file and said second task file;

5. The method of claim 4, further comprising the step of:
a. associating said first task file with said first triggering event such that when said first triggering event is placed on said activity timeline, said first task file is utilized to associate each of said first plurality of activities with a duration of time on said activity timeline; and
b. associating said second task file with said second triggering event, such that when said second triggering event is placed on said activity timeline, said second task file is utilized to associate each of said second plurality of activities with a duration of time on said activity timeline.

6. A method for improving an individual's performance of a routine, said individual having a plurality of cognitive resource channels, comprising:
a. proving a first task file, said first task file describing a first task performed in said routine as a first plurality of activities, said first task file containing a sequence and a duration for each of said first plurality of activities, said first task file further associating at least one of said cognitive resource channels with each of said first plurality of activities;
b. proving a second task file, said second task file describing a second task performed in said routine as a second plurality of activities, said second task file containing a sequence and a duration for each of said second plurality of activities, said first task file further associating at least one of said cognitive resource channels with each of said second plurality of activities;
c. providing a computer and fast time simulation software configured to construct an activity timeline by employing a plurality of task files including said first task file and said second task file;
d. using said computer and fast time simulation software to construct said activity timeline for said routine; and
e. using said computer and said fast time simulation software to determine a first interference on said activity timeline, said first interference corresponding to a first time on said activity timeline when a first activity and a second activity are performed simultaneously and the simultaneous performance of said first activity and said second activity results in cognitive interference.

7. The method of claim 6, further comprising the steps of:
a. observing said individual's performance of said routine;
b. identifying said first task and said second task performed by said individual when performing said routine; and
c. identifying a first plurality of discrete actions performed by said individual when performing said first task and a second plurality of discrete actions performed by said individual when performing said second task.

8. The method of claim 7, further comprising the step of developing a first generalized task model for said first task and a second generalized task model for said second task, said first generalized task model describing said first task as a first sequence of actions that occur each time said first task is performed, said second generalized task model describing said second task as a second sequence of actions that occur each time said second task is performed.

9. The method of claim 8, wherein said first generalized task model is used to construct said first task file and said second generalized task model is used to constrict said second task file.

10. The method of claim 6, further comprising adjusting said routine to ameliorate said first interference.
